(19) United States
(12) Patent Application Publication
(10) Pub. No.: US 2015/0221203 A1
(43) Pub. Date: Aug. 6, 2015

(54) GENERATOR MODULAR CONTINUOUS MONITORING SYSTEM WITH REMOTE ACCESS CAPABILITY

(71) Applicant: Siemens Energy, Inc., Orlando, FL (US)

(72) Inventors: Allan G. Concepcion, Furlong, PA (US); Madhukar Vachharajani, Hamilton Township, NJ (US); Edward R. Griffin, Tomball, TX (US)

(73) Assignee: Siemens Energy, Inc., Orlando, FL (US)

(21) Appl. No.: 14/173,842

(22) Filed: Feb. 6, 2014

(51) Int. Cl. G08B 21/18

(52) U.S. Cl. CPC G08B 21/18

(57) ABSTRACT

A monitoring system for electrical generators is disclosed The system continuously monitors sensor data from the generator and other electrical and mechanical equipment in a power plant, including data from sensors of different signal types, and data from existing control systems The monitoring system stores the data and analyzes it for both current conditions and time-based trends, and provides alarms for out-of-range conditions. The monitoring system also displays the data in an array of interface screens which make it easy for an operator to evaluate the performance of all of the systems in the power plant Remote access to the monitoring system from computers or mobile devices is also provided

### BACKGROUND OF THE INVENTION

1. Field of the Invention

This invention relates generally to monitoring operation of electrical generators and, more particularly, to a generator continuous monitoring system which collects sensor data from an electrical generator and its connected systems and components, analyzes the data using algorithms developed to detect trends in the data which indicate a certain condition needs attention, and displays trended data in display screens for easy visualization and comprehension by an operator.

2. Description of the Related Art

Electrical generators of the type used by utilities and large Industrial Plants to generate electricity are large and complex machines Such generators are typically operated in a power plant including a steam or gas turbine, the generator, and other machines such as pumps, compressors, etc. These power plants are usually designed such that the plant operator has extensive monitoring capability for the turbine and the other machines, but limited monitoring capability for the generator.

When a condition arises in the generator—or the turbine or other machinery—which needs maintenance attention, it is important for the operator to be aware of the condition as soon as possible, so that it may be addressed before serious damage is done to the generator or other equipment, or an unscheduled shutdown is required However, due to the plant operator's limited capability to monitor the generator—and its interactions with the other machinery—conditions may develop which go undetected. It is also important for the operator to be aware of the operating conditions of the generator and other equipment, in order to keep all parameters within normal operating ranges and maintain the best possible efficiency.

Furthermore, power plants have a long operational life, and many plants still use old sensor technology for monitoring the turbine and other machinery These plants need improved electrical generator monitoring capability without being required to undergo an expensive upgrade of sensors and data collection systems.

Other electrical equipment also exists in power plants—such as synchronous condensers and generator automatic voltage regulators. It is also important to monitor the condition of these devices, along with data monitored on the generator and other devices, in order to ensure peak efficiency of the power plant and avoid costly and unnecessary repairs

### SUMMARY OF THE INVENTION

In accordance with the teachings of the present invention, a monitoring system for electrical generators is disclosed The system continuously monitors sensor data from the generator and other electrical and mechanical equipment in a power plant, including data from sensors of different signal types, and data from existing control systems The monitoring system stores the data and analyzes it for both current conditions and time-based trends, and provides alarms for out-of-range conditions. The monitoring system also displays the data in an array of interface screens which make it easy for an operator to evaluate the performance of all of the systems in the power plant. Remote access to the monitoring system from computers or mobile devices is also provided

Additional features of the present invention will become apparent from the following description and appended claims, taken in conjunction with the accompanying drawings.

### BRIEF DESCRIPTION OF THE DRAWINGS

FIG. 1 is a schematic diagram of a power plant including a continuous monitoring system for an electrical generator and other equipment;

FIG. 2 is a block diagram of the generator monitoring system;

FIG. 3 is an illustration of the general layout of a display screen in the generator monitoring system,

FIG. 4 is an illustration of a turbine display screen in the generator monitoring system;

FIG. 5 is an illustration of a generator stator windings display screen in the generator monitoring system,

FIG. 6 is an illustration of a generator rotor display screen in the generator monitoring system,

FIG. 7 is an illustration of a generator electrical display screen in the generator monitoring system;

FIG. 8 is an illustration of a vibration display screen in the generator monitoring system,

FIG. 9 is an illustration of an auxiliaries display screen in the generator monitoring system,

FIG. 10 is an illustration of a time history data display screen in the generator monitoring system; and

FIG. 11 is a flowchart diagram of a method for continuous monitoring of an electrical generator and other equipment in a power plant

### DETAILED DESCRIPTION OF THE EMBODIMENTS

The following discussion of the embodiments of the invention directed to a generator modular continuous monitoring system is merely exemplary in nature, and is in no way intended to limit the invention or its applications or uses.

Electrical generators of the type used to generate electricity for utilities are large, complex machines In order to minimize downtime and expensive repairs, and ensure peak operating efficiency, it is important to continuously monitor the operating conditions of generators and other equipment in a power plant.

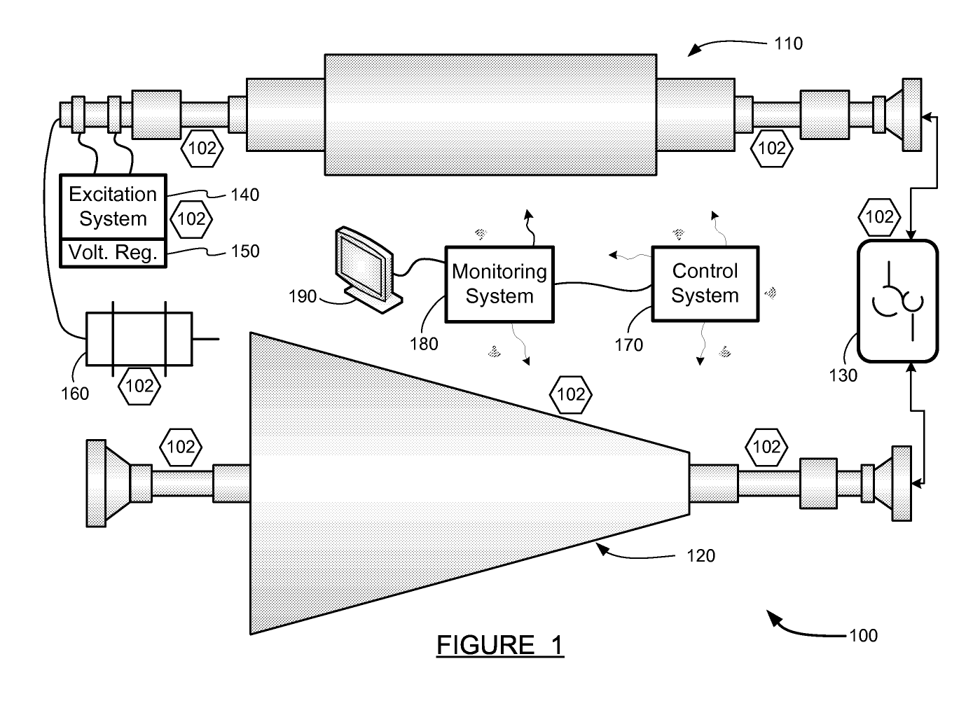

FIG. 1 is a schematic diagram of a power plant 100 including a continuous monitoring system for an electrical generator and other equipment A generator 110 generates electricity for use by homes and/or businesses in a region A turbine 120, which could be a steam turbine or a gas turbine, for example, drives the generator 110 via a gearbox 130 or other coupling device An excitation system 140 provides a field voltage and current to the generator 110, thus establishing how much electricity is produced. A voltage regulator 150, such as a generator automatic voltage regulator (GAVR) may be used in conjunction with the excitation system 140 to automatically establish the generator field voltage in response to demand for electricity.

A synchronous condenser 160 may be used in the power plant 100 to improve the power factor, as would be understood by those skilled in alternating current (AC) electrical power generation and consumption. A control system 170 is used to control operations of the power plant 100, including the turbine 120 in particular. The control system 170 inherently includes the capability to monitor some conditions in the power plant 100. Sensors 102 in the turbine 120 and in the other equipment provide data to the control system 170 via wired or wireless communication The sensors 102 may include a wide variety of sensor types, including but not limited to temperature sensors, pressure sensors, vibration sensors, force and torque sensors, voltage sensors, current sensors, speed (RPM) sensors, and others The control system 170 includes, at a minimum, the ability to start, stop and regulate the turbine 120 The control system 170 may not be designed to receive data from all of the sensors 102 in the power plant 100, particularly the sensors 102 associated with the generator 110, the excitation system 140, the voltage regulator 150, and the synchronous condenser 160

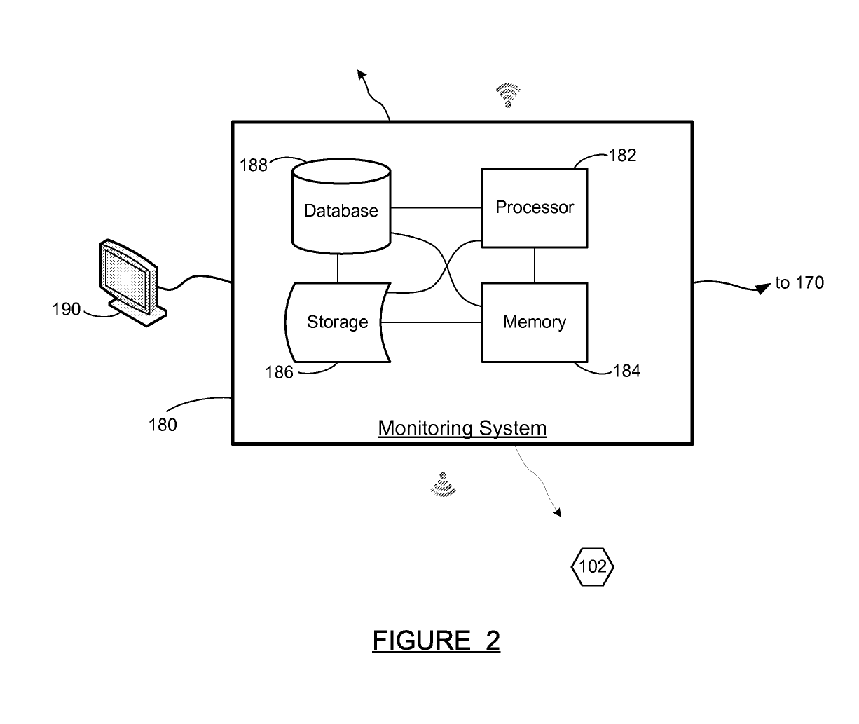

A monitoring system 180 communicates with the control system 170 and all of the sensors 102 in the power plant 100 to provide complete, continuous monitoring of all systems—with particular emphasis on the electrical equipment. FIG. 2 is a block diagram of the monitoring system 180, which is in wired or wireless communication with the sensors 102 and the control system 170, as discussed above. The monitoring system 180 includes, at a minimum, a processor 182, a memory module 184 and a data storage device 186, as would be found in any general-purpose or special-purpose computer. The processor 182 is configured with algorithms to analyze and display the collected data, as discussed in detail below. The monitoring system 180 also includes a database 188, such as a relational database, for organizing and indexing the collected data. The monitoring system 180 communicates with a display device 190 which displays both raw and processed data, provides other information and messages to the operator, and serves as an interface device for the operator's interaction with the monitoring system 180. The operator could interact with the monitoring system 180 via a mouse and keyboard, and the display device 190 may also include touch screen capability.

Operators of power plants such as the power plant 100 shown in FIG. 1 typically have a fairly good understanding of the operational status of the turbine 120 and other mechanical equipment, such as pumps, etc However, power plant operators often do not have a good understanding of the operational status of the generator 110 and other electrical equipment, nor of the interactions between the turbine 120, the generator 110 and the other equipment. The monitoring system 180 is designed to address this issue by providing robust data collection, analysis and display across all systems and components in the power plant 100

In many cases, the power plant 100 will have been designed, built and operated for years without the monitoring system 180. In order for the monitoring system 180 to be effectively incorporated in the power plant 100, it is important that the monitoring system 180 be able to communicate with all of the sensors 102 and with the control system 170. For example, the sensors 102 on the turbine 120 may be old-technology sensors which provide analog data signals, while the sensors 102 on the generator 110 and the synchronous condenser 160 may all be digital. Furthermore, some of the sensors 102 may require data acquisition or signal conditioning adapters which already exist in the control system 170; in these cases, it is advantageous to obtain the conditioned sensor data signals from the control system 170. In fact, any of the sensors 102 which are communicating with the control system 170 can provide their data channels to the monitoring system 180 via the control system 170 The sensors 102 which are not communicating with the control system 170 can have their data signals received directly by the monitoring system 180. Thus, the monitoring system 180 can be configured to allow sensor data channels to be defined to take advantage of the best available data source.

The monitoring system 180 provides a wide range of display options to enable an operator to evaluate both current conditions and performance trends in the generator 110 and the other equipment in the power plant 100, as will be described in the discussion of the following figures.

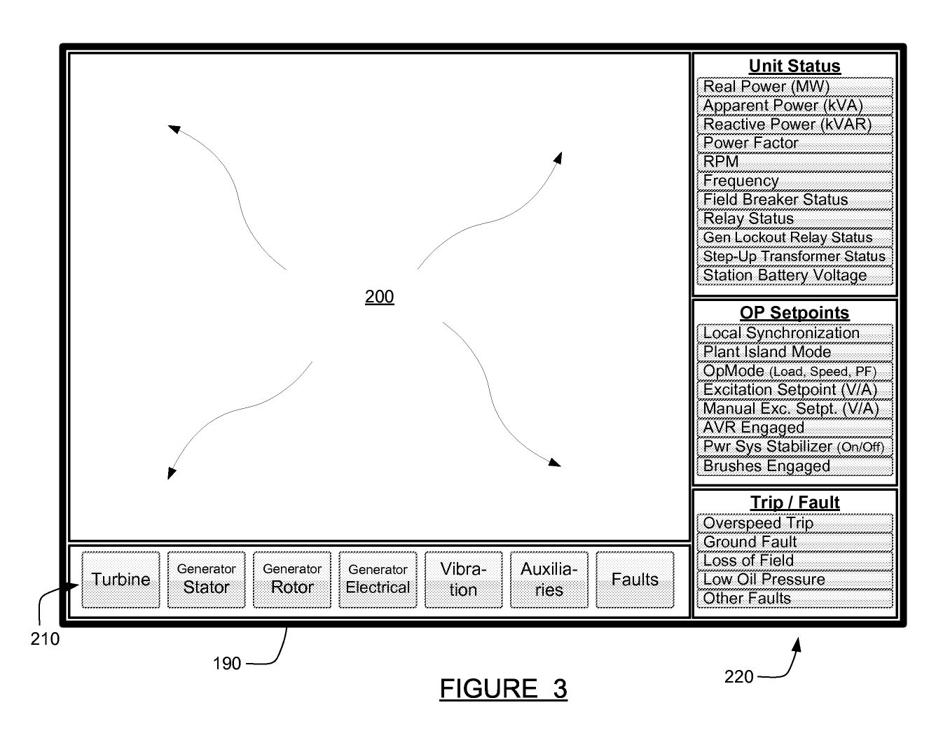

FIG. 3 is an illustration of the general layout of a display screen in the generator monitoring system 180 The display device 190 is shown as the outside border in FIG. 3. A main window 200 provides a visual display of important conditions for any of several different screens The screens are selected via the buttons in a screen selector bar 210. As can be seen in FIG. 3, the screens available for selection in the screen selector bar 210 include a turbine display screen, a generator stator windings display screen, a generator rotor display screen, a generator electrical display screen, a vibration display screen, an auxiliaries display screen, and a faults display screen. Each of these screens will be shown and described in detail in subsequent figures

A right-side status bar 220 provides a continuous display of key parameters across all display screens A Unit Status section includes a display of several parameters associated with the generator 110, focusing on the electrical power being produced. The Unit Status section includes, for example, real power being produced by the generator 110, apparent and reactive power, power factor, generator speed (RPM), frequency of the AC power, and status of generator breakers, relays and transformers

An Operating Setpoints section includes a display of several parameters related to the control of the generator 110 and associated equipment such as the excitation system 140, the voltage regulator 160 and the synchronous condenser 160 A Trip/Fault section includes a display of several key fault parameters which may be encountered, such as an overspeed condition, a ground fault or low oil pressure Other parameters could, of course, be included in the right-side status bar 220, either in one of the existing three sections, or in an additional section

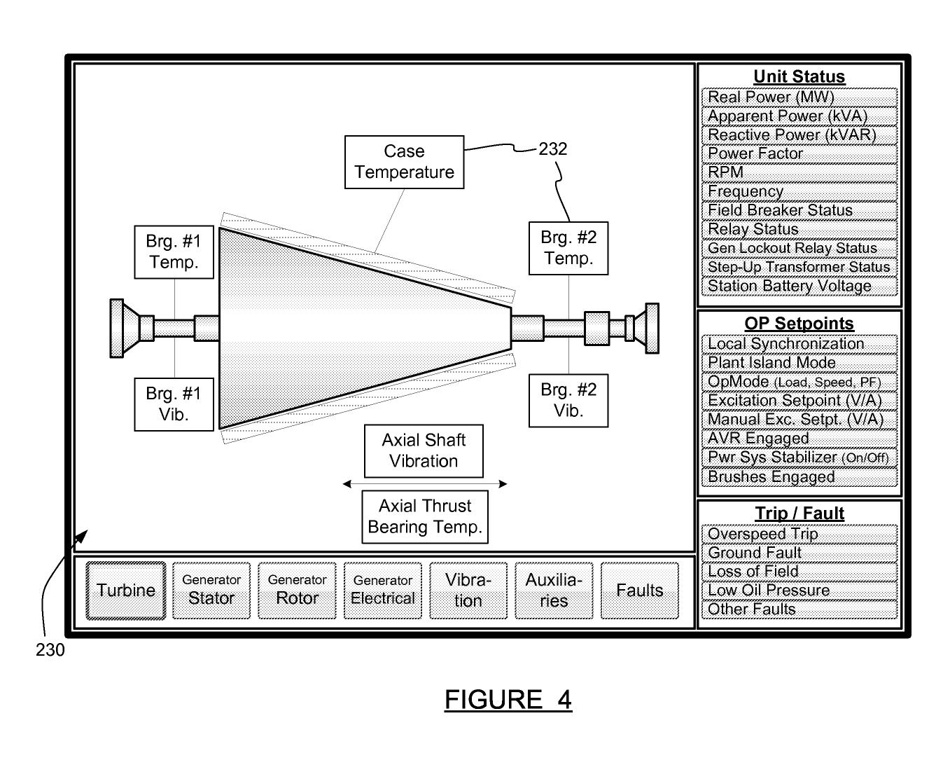

FIG. 4 is an illustration of a turbine display screen 230 in the generator monitoring system 180. The turbine display screen 230 is selected by the operator by touching the “Turbine” button in the screen selector bar 210, or by clicking on the button with a mouse In a similar fashion, each of the screens discussed below can be selected from the screen selector bar 210

The turbine display screen 230 includes a visual depiction of the turbine 120, along with data display boxes 232 which contain current data for a number of key parameters related to the turbine 120. The data display boxes 232 generically represent the boxes displaying data on all display screens, not just the turbine display screen 230 In one embodiment, the data display boxes 232 for the turbine display screen 230 include case temperature, temperature of the bearings at both the generator-coupling end (#2) and the free end (#1) of the turbine, vibration amplitude of the bearings at both the generator-coupling end and the free end of the turbine, temperature of the axial thrust bearing, and axial shaft vibration amplitude.

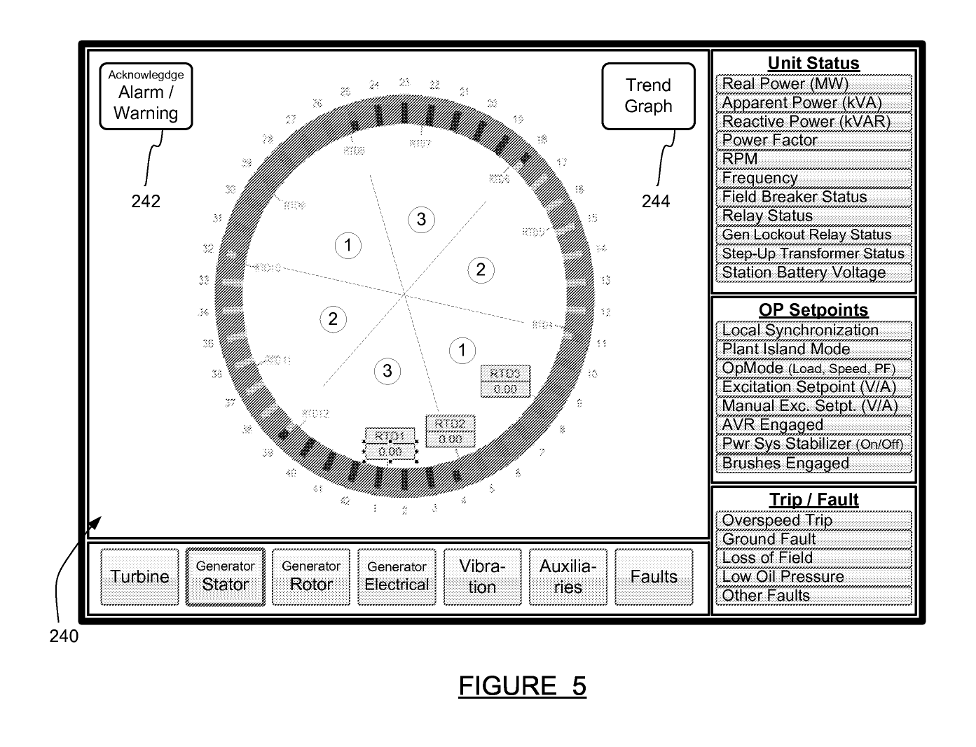

FIG. 5 is an illustration of a generator stator winding display screen 240 in the generator monitoring system 180. The generator stator winding display screen 240 includes a visual depiction of the generator stator in cross-section, showing the slots of the winding (42 slots in this case) by phase group (phase 1, 2 or 3—indicated by the encircled numerals). In one embodiment, the data display boxes 232 for the generator stator winding display screen 240 include winding temperature as determined by a plurality of resistance temperature detectors (RTDs) located around the stator. The display of the winding temperatures at the RTDs can include warning and alarm indicators, where a yellow warning light indicates that a temperature value exceeds a high or low warning setting, and a red alarm light indicates that a temperature value exceeds a high or low alarm setting. A solid light indicates that the value currently exceeds the alarm setting, while a blinking light indicates that the value exceeded the alarm setting in the past but is currently within range and is awaiting acknowledgement via a touch of an acknowledge button 242

The stator winding display screen 240 also includes a trend graph button 244, which changes the screen to display a time history (trend) graph of all of the RTD data Alternately, the operator can touch any individual RTD value, which changes the screen to display a trend graph of just the selected RTD temperature data In trend graphs, the operator can zoom in and separate data by either time interval or magnitude Trend data can also be exported to a spreadsheet upon a command by the operator

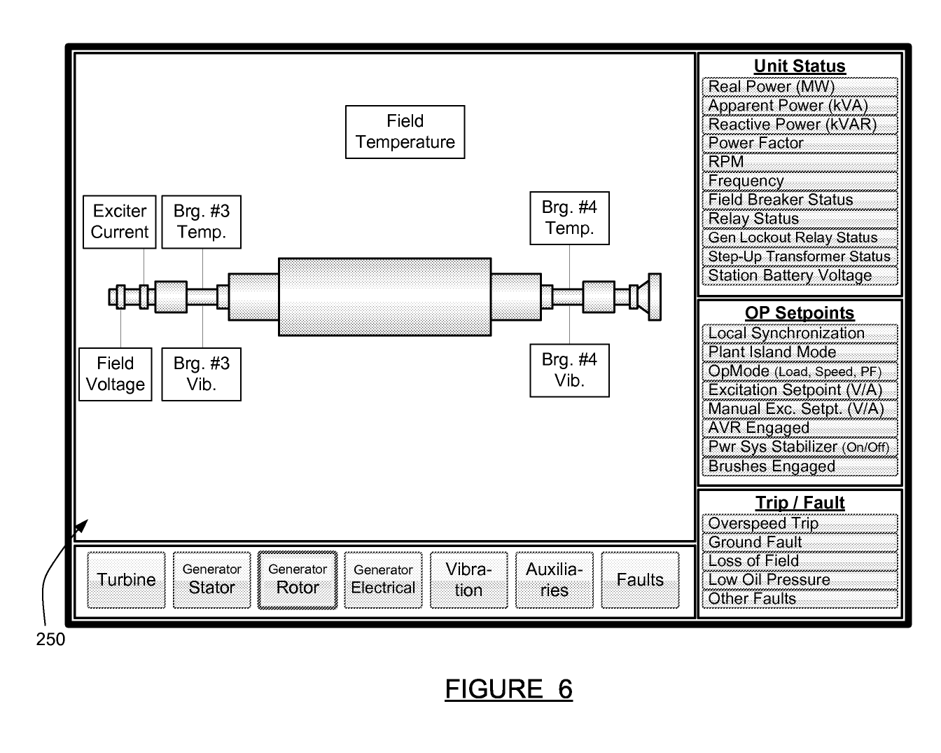

FIG. 6 is an illustration of a generator rotor display screen 250 in the generator monitoring system 180. The generator rotor display screen 250 includes a visual depiction of the generator 110, along with data display boxes 232 which contain current data for a number of key parameters related to the rotor of the generator 110 In one embodiment, the data display boxes 232 for the generator rotor display screen 250 include excitation field voltage and current, temperature of the bearings at both the turbine-coupling end (#4) and the exciter end (#3) of the generator 110, vibration amplitude of the bearings at both the turbine-coupling end and the exciter end of the generator 110, and field temperature—which may be calculated from rotor winding resistance rather than measured directly.

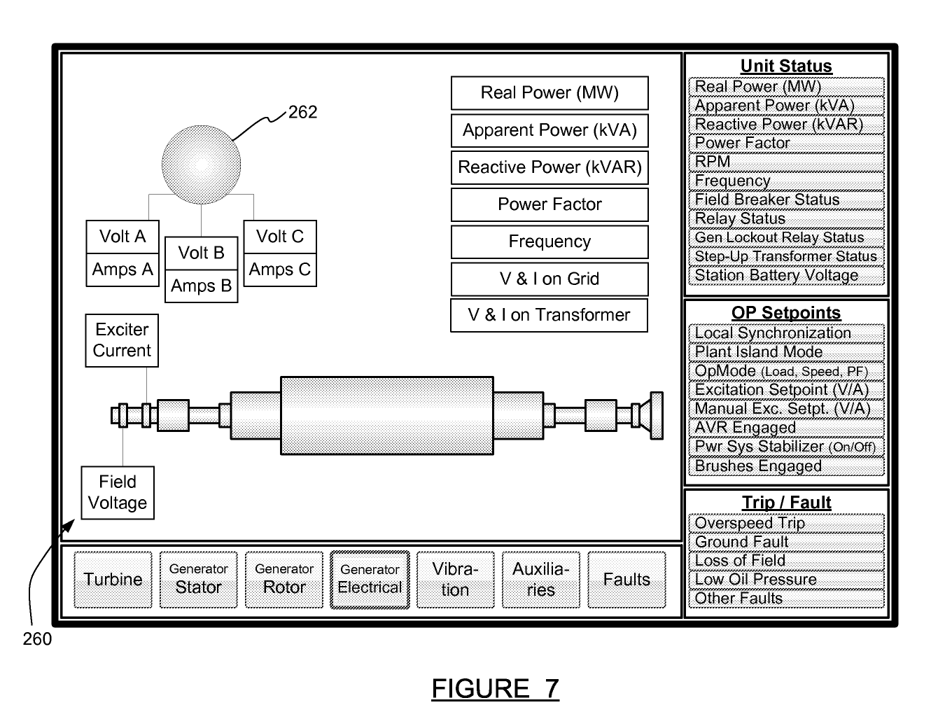

FIG. 7 is an illustration of a generator electrical display screen 260 in the generator monitoring system 180. The generator electrical display screen 260 includes a visual depiction of the generator 110, along with data display boxes 232 which contain current data for a number of key parameters related to the electrical power being generated by the generator 110. In one embodiment, the data display boxes 232 for the generator electrical display screen 260 include excitation field voltage and current, voltage and current output for each of the three phases on a phase status display 262, and a number of generator power parameters. The generator power parameters may include real power, apparent power, reactive power, power factor, frequency of the AC power signal, voltage and current on the grid, and voltage and current on the transformer Other generator power parameters can be included on the generator electrical display screen 260 as needed.

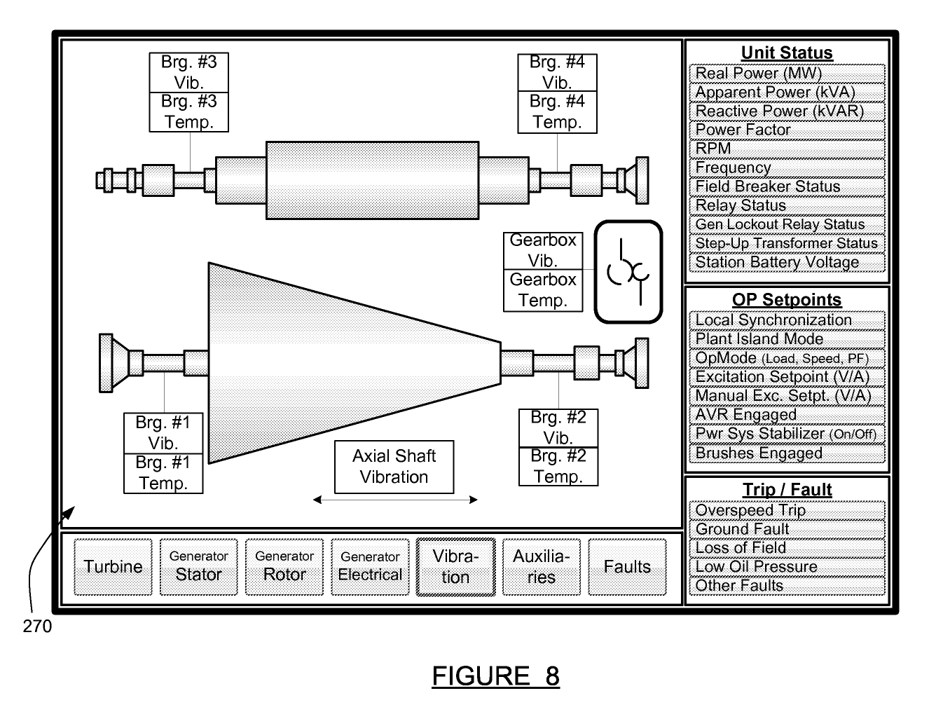

FIG. 8 is an illustration of a vibration display screen 270 in the generator monitoring system 180. The vibration display screen 270 includes a visual depiction of the generator 110, the turbine 120 and the gearbox 130, along with data display boxes 232 which contain current data for a number of vibration and temperature parameters related to these three devices In one embodiment, the data display boxes 232 for the vibration display screen 270 include vibration amplitude and temperature for the bearings at each end of both the generator 110 and the turbine 120, vibration and temperature for the gearbox 130, and axial shaft vibration of the turbine 120. Other vibration-related parameters could be included on the vibration display screen 270 as needed.

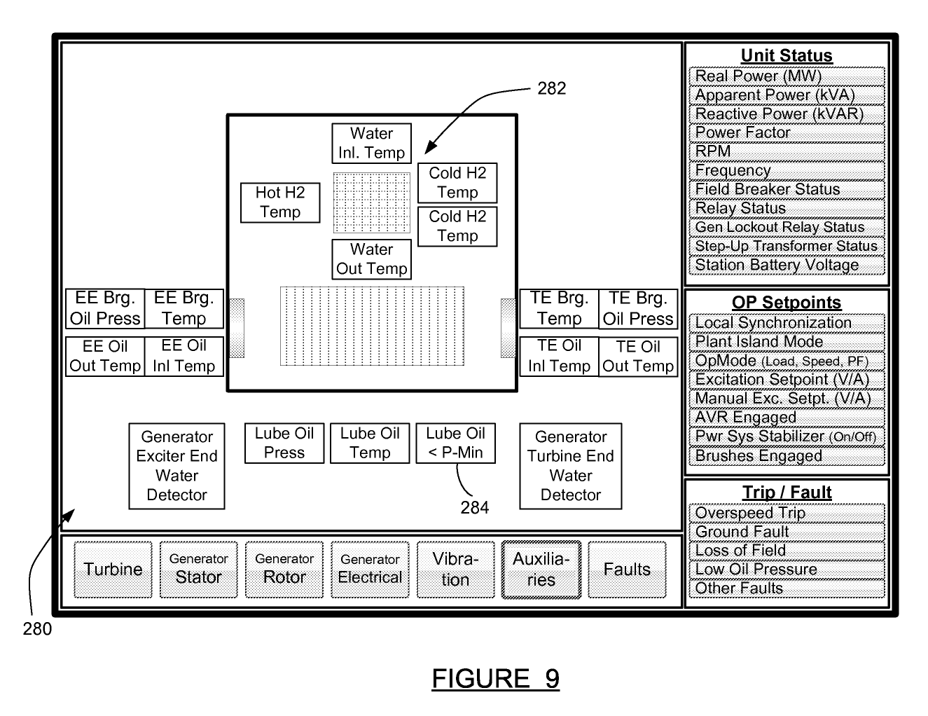

FIG. 9 is an illustration of a generator auxiliaries display screen 280 in the generator monitoring system 180. The auxiliaries display screen 280 includes a visual depiction of a generator heat exchanger 282 with intake and outlet temperatures of both water and air, along with data display boxes 232 which contain current data related to the lube oil and jacking oil subsystems in the generator 110. In one embodiment, the data display boxes 232 for the auxiliaries display screen 280 include temperature and bearing oil pressure for each generator bearing, oil inlet and outlet temperature for each bearing, and temperature and pressure of both jacking oil and lube oil. In addition, one or more alarm display 284 is included on the auxiliaries display screen 280, where the alarm display 284 could indicate an alarm condition for low oil pressure at any of the bearings, high differential pressure at a lube or jacking oil filter, or any other condition The auxiliaries display screen 280 also includes water detection indicators at both the turbine end and the exciter end of the generator 110, where the water could be detected by a traditional liquid water detection device or a humidity sensor which could detect a fine leak.

A “Faults” screen (not shown) is also accessible via a button in the screen selector bar 210. The Faults screen can display any warnings or alarms from any of the other display screens, or any other warning or alarm which may be detected by the monitoring system 180 The Faults screen can indicate whether parameters are currently exceeding warning or alarm limits or exceeded the limits in the past Warnings and alarms can also be acknowledged or cleared from the Faults screen All warnings and alarms are maintained in a historical log

The generator monitoring system 180 also includes remote access capability, via either a computer or a mobile device, to enable an operator or technician to evaluate operational status when not on site at the power plant 100. The remote access feature may provide HyperText Markup Language (HTML) pages which can be accessed via a web browser application on either a remote computer or a mobile device. The HTML pages provide both display and interaction features for the monitoring system 180. A customized application can also be used as a client running on a remote computer or a mobile device, where the client application accesses data from the monitoring system 180 and displays the data on the remote computer or mobile device, including the display screens and features described above A computer-based client application could access the monitoring system data via a virtual private network (VPN) connection, while a mobile device could have an application which is programmed to retrieve data from a server via cellular data communication In any case, the ability of an operator or technician to evaluate operational status when not on site at the power plant 100 can be a very valuable enabler of rapid decision making.

The generator monitoring system 180 performs many types of analysis of the data in order to evaluate performance trends and detect impending problems which may not yet be reflected in real-time data Time history data for any sensor data channel can be viewed to allow an operator to gain a detailed understanding of performance over time In addition, data analysis routines can run continuously which can detect performance trends which may need attention, as will be discussed below.

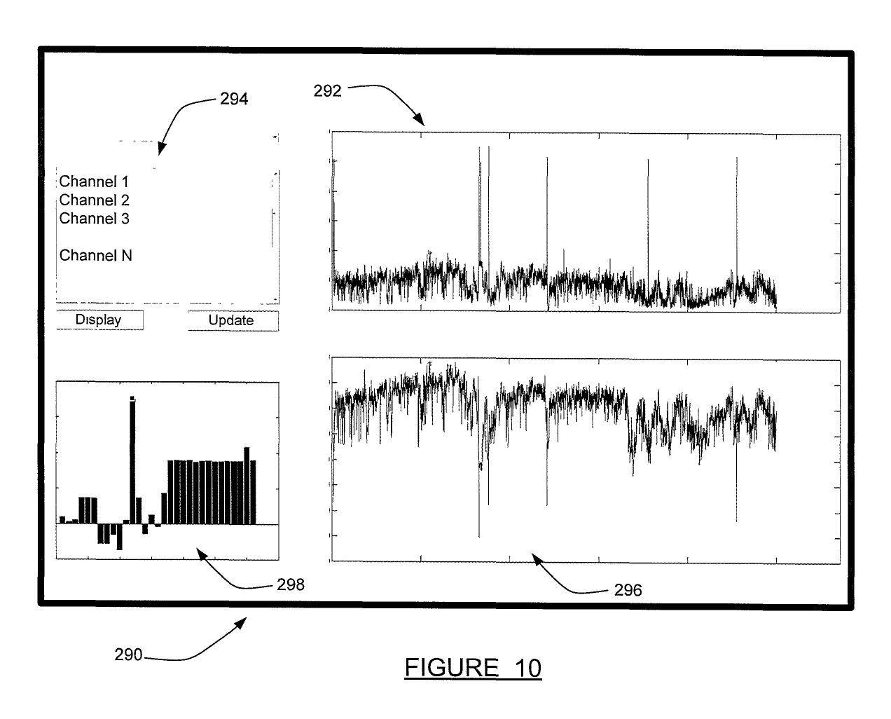

FIG. 10 is an illustration of a data display screen 290 in the generator monitoring system 180 The data display screen 290 can be accessed by touching or mouse-clicking any of the data display boxes 232 on any of the display screens discussed above. In one embodiment, touching or mouse-clicking one of the data display boxes 232 would result in the data display screen 290 displaying time history data for the parameter in the data display box 232 which was selected. The selected parameter's time history data would be displayed in window 292. A list of all data channels would be available for selection in window 294 A second data channel could be selected for display in window 296, where the multi-variate display could enable the operator to understand a cause or effect of an anomaly by viewing two data channel time traces one above the other The data graphs in the windows 292 and 296 would allow the operator to click on a peak, which would result in a bar graph in window 298 indicating which data channel contributed to the deviation and the positive or negative magnitude of that contribution and possible correlation.

In addition to the data display capability shown on the data display screen 290, the generator monitoring system 180 can run data monitoring routines continuously during the operation of the power plant 100. Taken together, the background data analysis and the visual data analysis allow the power plant operator to evaluate trends in behavior of the generator 110 and other equipment, and to manage risk.

An example can be used to illustrate how data analysis is used to diagnose generator operational issues In a graph of heat exchanger air outlet temperature, viewed in the window 292 of the data display screen 290, a peak indicates a temperature significantly above the baseline value. When observed in conjunction with a water leak fault from the Faults screen (or from the generator auxiliaries display screen 280), and rising stator and rotor winding temperatures, the data indicates probable issues with the efficiency of the stator air-to-water heat exchanger 282. In this situation, immediate shutdown of the unit would be recommended to service the heat exchanger 282, clear blocked tubes and fix water leaks This immediate response to anomalies in the data can prevent extensive and expensive damage to the generator which would certainly result from overheating.

In another example, a generator exciter end vibration amplitude above the baseline value is detected, while vibration at the turbine drive end of the generator 110 is normal or below normal It is also observed that there is a slight increase in rotor exciter current, not consistent with generator load These factors would suggest that there are potential issues with shorted turns on the rotor, or issues with the brushless exciter, but the issues are not sufficient to warrant shutdown. In this situation, fault testing of the rotor and the brushless exciter would be recommended at the next generator shutdown.

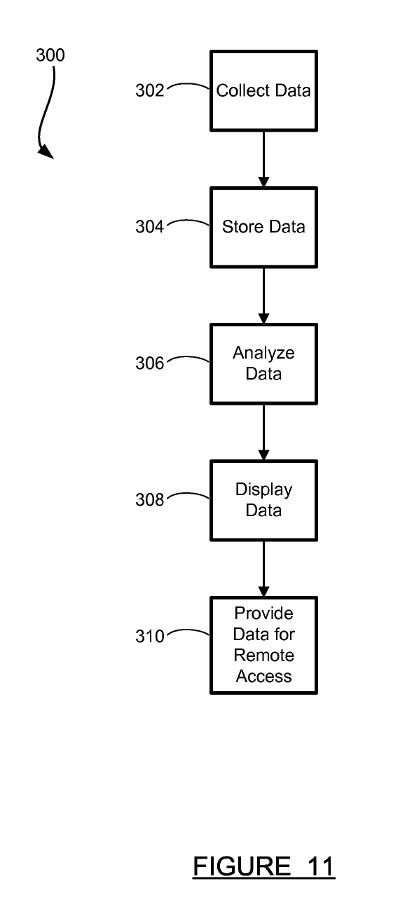

FIG. 11 is a flowchart diagram 300 of a method for continuous monitoring of the electrical generator 110 and other equipment in the power plant 100 At box 302, data is collected from the generator 110 and the other equipment in the power plant 100. The other equipment could include the turbine 120, the gearbox 130 or other coupling device, the excitation system 140, the voltage regulator 150, the synchronous condenser 160 and the control system 170 Data can be collected directly from the sensors 102 which are fitted to the equipment, and data can also be collected from the control system 170 for data channels which are already being monitored by the control system 170.

At box 304, the collected data is stored by the monitoring system 180 Both the memory module 184 (such as random access memory, or RAM) and the storage device 186 can be used for data storage, where incoming data can be stored in the memory module 184 for a certain period of time for real-time analysis and display, and then the data can be written to the storage device 186 for medium-term storage and analysis. Long-term historical data can be archived to a tape or optical disk archive medium if desired, where archiving could be included in the storage device 186. The monitoring system 180 is designed to store collected data for several years, in order to enable long-term data trending analysis.

At box 306, the collected data is analyzed by the monitoring system 180. As discussed above, the analysis can include both pre-programmed analysis routines which run in a background mode in the monitoring system 180 and on-demand analysis as requested by the system operator. The analysis includes monitoring for any data value which exceeds a warning or alarm level setting, ongoing calculation of baseline values for each data channel, and other custom calculations associated with the generator 110 and the other equipment. Using data collected from all of the sensors, the behavior of the generator components can be analyzed for trends related to component degradation, operational issues, or correlated with issues from the turbine 120, the excitation system 140, the automatic voltage regulator 150, or auxiliaries such as the lube oil system or cooling system. These trends can be used to determine the likelihood of generator component failure, estimate the risk of component failure in a given time period, determine if adjustments need to be made to the operation of the power plant 100, and determine if an issue manifesting in the generator 110 is actually being caused by an associated piece of machinery such as the turbine 120, the gearbox 130, etc.

At box 308, the collected data is displayed on the display device 190 in the form of any of the screens 230-290 described previously The plant operator interacts with the monitoring system 180 to continuously view and analyze the data during operation of the power plant 100, and adjust or intervene as necessary based on the observed performance of the generator 110 and the other equipment

At box 310, the collected data is provided for remote access by an operator or technician who is not on site at the power plant 100. As discussed previously, the remote access could be performed from an off-site computer which accesses web pages from the monitoring system 180 or connects directly to the monitoring system 180 via a VPN tunnel. The remote access could also be in the form of a smart phone application running on a mobile device which accesses the data in the monitoring system 180 via a cellular communication network

Using the systems and methods described above, the performance of all equipment in a power plant can be monitored, performance trends can be evaluated, and current and impending problems can be detected The real-time monitoring of power plant operational parameters allows operators to maintain peak efficiency, reduce downtime and maintenance costs, and prolong the productive life of the generators and related equipment in the power plant.

The foregoing discussion discloses and describes merely exemplary embodiments of the present invention One skilled in the art will readily recognize from such discussion and from the accompanying drawings and claims that various changes, modifications and variations can be made therein without departing from the spirit and scope of the invention as defined in the following claims.

What is claimed is:

1. A system for monitoring an electrical generator and other equipment in a power plant, said system comprising.
a plurality of data collection channels for receiving data from sensors in the generator and the other equipment;
a processor configured to analyze the data as it is collected, evaluate performance trends in the data, issue warnings and alarms for any condition of the generator or the other equipment which requires immediate attention, and present the data on a plurality of customized display screens;
a memory module for temporarily storing the data and programming instructions for the processor,
a storage device for permanently storing the data; and
a display device for displaying the data and other information on the plurality of customized display screens, said display device also allowing an operator to interact with the system.

2. The system of claim 1 wherein the other equipment includes a turbine, a gearbox which couples the turbine to the generator, a generator excitation system, a generator automatic voltage regulator, and a synchronous condenser

3. The system of claim 1 wherein the plurality of data collection channels receives data from a power plant control system.

4. The system of claim 1 wherein the plurality of customized display screens includes a turbine status screen, a generator stator status screen, a generator rotor status screen, a generator electrical status screen, a vibration status screen, a generator auxiliaries screen, and a time history data display screen

5. The system of claim 4 wherein the turbine status screen includes a display of a turbine and data display boxes for case temperature, temperature and vibration amplitude at a free end of the turbine, temperature and vibration amplitude at a generator coupling end of the turbine, axial shaft vibration amplitude and axial thrust bearing temperature.

6. The system of claim 4 wherein the generator stator status screen includes a display of a cross-section of a generator stator showing slots in the stator and a phase relationship of the slots, and further includes a plurality of temperature displays around the cross-section of the stator, where the temperature displays indicate temperature values obtained from resistance temperature detectors

7. The system of claim 4 wherein the generator rotor status screen includes a display of the generator and data display boxes for field temperature, temperature and vibration amplitude at an exciter end of the generator, temperature and vibration amplitude at a turbine coupling end of the generator, exciter current and field voltage.

8. The system of claim 4 wherein the generator electrical status screen includes a display of the generator and data display boxes for exciter current, field voltage, voltage and current for each of three phases of generated electricity, real power, apparent power, reactive power, power factor, frequency of the generated electricity, voltage and current on an electrical grid, and voltage and current on a transformer.

9. The system of claim 4 wherein the vibration status screen includes a display of a turbine, a gearbox and the generator, and data display boxes for temperature and vibration amplitude at a free end of the turbine, temperature and vibration amplitude at a generator coupling end of the turbine, temperature and vibration amplitude at an exciter end of the generator, temperature and vibration amplitude at a turbine coupling end of the generator, temperature and vibration amplitude of the gearbox and axial shaft vibration amplitude.

10. The system of claim 4 wherein the generator auxiliaries status screen includes a display of a generator heat exchanger and data display boxes for heat exchanger water inlet and outlet temperature, heat exchanger air inlet and outlet temperature, bearing temperature, bearing oil pressure and bearing oil inlet and outlet temperature for both exciter end and turbine end bearings, lube oil pressure and temperature, an alarm display for low oil pressure, and water detector alarms for both the exciter end and the turbine end of the generator.

11. The system of claim 4 wherein the time history data display screen includes at least two windows for displaying time history data for selected data channels, a window containing a list of data channels to be selected for time history display, and a window for displaying contributions and correlations between the selected data channels.

12. The system of claim 1 wherein the processor is further configured to provide remote access to the system to an off-site user

13. The system of claim 12 wherein the remote access is provided via an application running on a smart phone device.

14. A system for monitoring an electrical generator and other equipment in a power plant, said system comprising:
a plurality of data collection channels for receiving data from sensors in the generator and the other equipment, where the other equipment includes a turbine, a gearbox which couples the turbine to the generator, a generator excitation system, a generator automatic voltage regulator, and a synchronous condenser,
a processor configured to analyze the data as it is collected, evaluate performance trends in the data, issue warnings and alarms for any condition of the generator or the other equipment which requires immediate attention, and present the data on a plurality of customized display screens, where the plurality of customized display screens includes a turbine status screen, a generator stator status screen, a generator rotor status screen, a generator electrical status screen, a vibration status screen, a generator auxiliaries screen, and a time history data display screen,
a memory module for temporarily storing the data and programming instructions for the processor;
a storage device for permanently storing the data; and
a display device for displaying the data and other information on the plurality of customized display screens, said display device also allowing an operator to interact with the system

15. The system of claim 14 wherein the processor is further configured to provide remote access to the system to an off-site user via an application running on a smart phone device

16. A method for monitoring an electrical generator and other equipment in a power plant, said method comprising.
collecting data from a plurality of sensors in the generator and the other equipment,
storing the data in a storage device,
analyzing the data, using a microprocessor, to evaluate performance trends in the data, issue warnings and alarms for any condition of the generator or the other equipment which requires immediate attention, and present the data on a plurality of display screens; and
displaying the display screens on a display device, where the display screens include a turbine status screen, a generator stator status screen, a generator rotor status screen, a generator electrical status screen, a vibration status screen, a generator auxiliaries screen, and a time history data display screen

17. The method of claim 16 further comprising proving remote access to the display screens

18. The method of claim 17 wherein the remote access is provided via an application running on a smart phone device

19. The method of claim 16 wherein collecting data includes collecting data from a power plant control system as well as from the plurality of sensors.

20. The method of claim 16 wherein the other equipment includes a turbine, a gearbox which couples the turbine to the generator, a generator excitation system, a generator automatic voltage regulator, and a synchronous condenser.
